(19) United States
(12) Patent Application Publication
(10) Pub. No.: US 2025/0153523 A1
(43) Pub. Date: May 15, 2025

(54) DEVICE FOR SUPPLYING POWER TO AN ELECTRIC VEHICLE

(71) Applicant: JUNG-CHIEH CHEN, HSINCHU CITY (TW)

(72) Inventor: JUNG-CHIEH CHEN, HSINCHU CITY (TW)

(21) Appl. No.: 18/604,708

(22) Filed: Mar. 14, 2024

(30) Foreign Application Priority Data
Nov. 13, 2023 (TW) 112212252

(51) Int. Cl. B60G 13/14; B60L 53/00

(52) U.S. Cl. CPC B60G 13/14; B60L 53/00; B60G 2206/41; B60G 2300/50; B60G 2800/162

(57) ABSTRACT

A device for supplying power to an electric vehicle includes a vibration absorber and an energy converter. The vibration absorber excludes damping. The vibration absorber vibrates up and down to generate vibration energy as the wheels of the electric vehicle vibrate up and down. The energy converter converts the vibration energy into electric energy and store the electric energy for use by the electric vehicle.

### BACKGROUND OF THE INVENTION

This application claims priority for the TW patent application Ser. No. 11/221,2252 filed on 13 Nov. 2023, the content of which is incorporated by reference in its entirely.

### FIELD OF THE INVENTION

The present invention relates to a device for supplying power to an electric vehicle, particularly to a device for supplying power to an electric vehicle that converts vibration energy into electric energy.

### DESCRIPTION OF THE RELATED ART

Compared with fuel vehicles, electric vehicles have poor endurance. Therefore, how to improve the endurance of electric vehicles has always been the direction of the efforts of vehicle manufacturers. As we all know, when a vehicle drives and encounters uneven road surfaces, the vehicle body will be impacted to vibrate up and down. For this reason, vibration absorbers with damping are commonly used on vehicles to reduce the impact on the driver and passengers. If the vibration energy of electric vehicles in driving can be converted into electrical energy for use by electric vehicles, it will effectively increase the endurance of electric vehicles.

### SUMMARY OF THE INVENTION

One objective of the present invention is to provide a device for supplying power to an electric vehicle.

According to an embodiment of the present invention, a device for supplying power to an electric vehicle includes a vibration absorber and an energy converter. The vibration absorber excludes damping. The vibration absorber vibrates up and down to generate vibration energy as the wheels of the electric vehicle vibrate up and down. The energy converter converts the vibration energy into electric energy and store the electric energy for use by the electric vehicle.

In the present invention, since the vibration absorber does not contain damping, the vibration absorber can generate greater vibration energy such that greater electric energy is obtained. The energy converter can convert the wheel's up-and-down vibration into horizontal rotation using a combination of sprockets and/or gears. Therefore, even if the vibration absorber has no damping, the driver and passengers of the electric vehicle will still not feel severe vibration. The device for supplying power to an electric vehicle of the present invention can achieve the vibration absorbing function.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a device for supplying power to an electric vehicle according to an embodiment of the present invention;

FIG. 2 is a schematic diagram illustrating an energy converter of FIG. 1 according to an embodiment of the present invention;

FIG. 3 is a schematic diagram illustrating a device for supplying power to an electric vehicle according to another embodiment of the present invention; and

FIG. 4 is a top view of an energy converter according to an embodiment of the present invention.

### DETAILED DESCRIPTION OF THE INVENTION

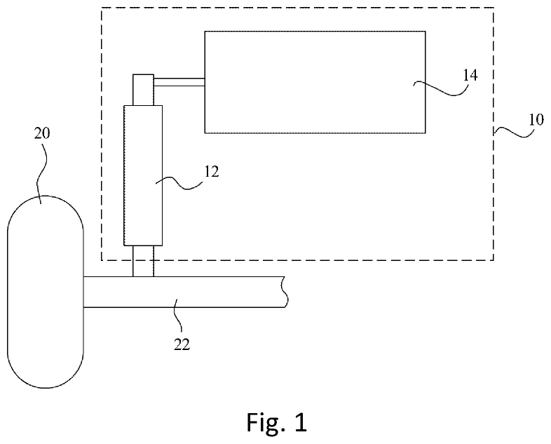

FIG. 1 shows an embodiment of a device for supplying power to an electric vehicle. The device 10 for supplying power to an electric vehicle of the present invention includes a vibration absorber 12 and an energy converter 14. The vibration absorber 12 excludes damping. The vibration absorber 12 may be, but not limited to, a part of the suspension system of the electric vehicle. In one embodiment, the vibration absorber 12 may be a MacPherson vibration absorber. In the embodiment of FIG. 1, the vibration absorber 12 is connected to the axle 22 of the wheel 20 of the electric vehicle, but the invention is not limited thereto. The vibration absorber 12 is connected to the energy converter 14. When the electric vehicle is traveling and the wheel 20 vibrates, the vibration absorber 12 will vibrate up and down along as the wheel 20 vibrates up and down, thereby generating vibration energy. The energy converter 14 converts the vibration energy generated by the vibration absorber 12 into electric energy and stores the electric energy for use by the electric vehicle. In the present invention, since the vibration absorber 12 does not include damping, the vibration absorber 12 can generate greater vibration energy such that greater electric energy is obtained. The energy converter 14 can convert the up-and-down vibration of the wheel 20 into horizontal rotation using a combination of sprockets and/or gears. Therefore, even if the vibration absorber 12 has no damping, the driver and passengers of the electric vehicle will still not feel severe vibration. The device 10 for supplying power to an electric vehicle of the present invention can achieve the vibration absorbing function.

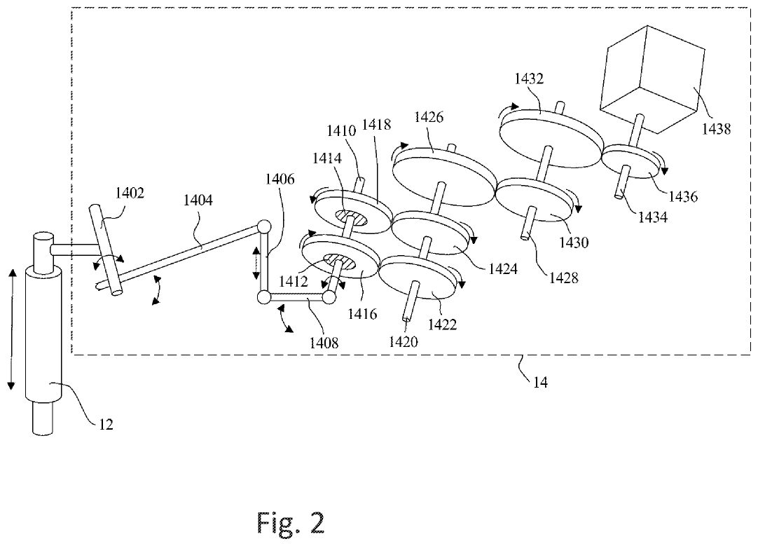

FIG. 2 shows an embodiment of the energy converter 14 in FIG. 1. The energy converter 14 includes a front amplifying arm 1402, a rear amplifying arm 1404, a connecting rod 1406, a short swinging arm 1408, a first transmission mechanism, a second transmission mechanism, and a power generator 1438. In the embodiment of FIG. 2, the first transmission mechanism includes a first rotating shaft 1410, a first non-return bearing 1412, a second non-return bearing 1414, a first sprocket 1416, and a first gear 1418, but the present invention is not limited thereto. For example, the first sprocket 1416 can be replaced by a gear and the first gear 1418 can also be replaced by a sprocket. In the embodiment of FIG. 2, the second transmission mechanism includes a second rotating shaft 1420, a second sprocket 1422, a second gear 1424, a third sprocket 1426, a third rotating shaft 1428, and a fourth sprocket 1430, a fifth sprocket 1432, a fourth rotating shaft 1434, and a sixth sprocket 1436, but the present invention is not limited thereto. For example, the second sprocket 1422 can be replaced by a gear and the second gear 1424 can also be replaced by a sprocket. In order to make the drawing simpler and easier to understand, the detailed structures of the components, such as the teeth of the gear and the chain belt of the sprocket, are omitted in FIG. 2

In the energy converter 14 of FIG. 2, the front amplifying arm 1402 is connected to the vibration absorber 12. When the vibration absorber 12 vibrates up and down, the front amplifying arm 1402 will rotate back and forth repeatedly. The rear amplifying arm 1404 is connected to the front amplifying arm 1402. When the front amplifying arm 1402 rotates back and forth, the rear amplifying arm 1404 will swing up and down. The connecting rod 1406 is connected to the rear amplifying arm 1404. When the rear amplifying arm 1404 swings up and down, the connecting rod 1406 will move up and down. The short swinging arm 1408 is connected to the connecting rod 1406. When the connecting rod 1406 moves up and down, the short swinging arm 1408 will swing up and down. The function of the front amplifying arm 1402 and the rear amplifying arm 1404 is to amplify the vibration of the vibration absorber 12 to generate greater vibration energy.

In FIG. 2, the first rotating shaft 1410 of the first transmission mechanism is connected to the short swinging arm 1408. When the short swinging arm 1408 swings up and down, the first rotating shaft 1410 will rotate back and forth repeatedly. The first non-return bearing 1412 and the second non-return bearing 1414 of the first transmission mechanism are arranged on the first rotating shaft 1410. The first sprocket 1416 and the first gear 1418 of the first transmission mechanism are respectively arranged on the first non-return bearing 1412 and the second non-return bearing 1414. When the first rotating shaft 1410 rotates forward (i.e., rotates clockwise or rotates in the first direction), the first sprocket 1416 will rotate forward and the second non-return bearing 1414 will prevent the first gear 1418 from rotating forward with the first rotation shaft 1410. When the first rotating shaft 1410 rotates backward (i.e., rotates counterclockwise or rotates in the second direction), the first gear 1418 will rotate backward and the first non-return bearing 1412 will prevent the first sprocket 1416 from rotating backward with the first rotating shaft. The action of the first transmission mechanism of the present invention is not limited to the foregoing description. For example, the first non-return bearing 1412 is used to prevent the first sprocket 1416 from rotating forward and the second non-return bearing 1414 is used to prevent the first gear 1418 from rotating backward. As a result, the first sprocket 1416 can only rotate backward and the first gear 1418 can only rotate forward. The function of the first transmission mechanism is to convert the vibration energy of upward vibration and the vibration energy of downward vibration into rotational energy in the same rotation direction.

In FIG. 2, the second sprocket 1422, the second gear 1424 and the third sprocket 1426 of the second transmission mechanism are arranged on the second rotating shaft 1420. The second sprocket 1422 is connected to the first sprocket 1416. When the short swinging arm 1408 swings upward such that the first sprocket 1416 rotates forward, the second sprocket 1422 will rotate forward, causing the second rotating shaft 1420 to rotate forward. The second gear 1424 is connected to the first gear 1418. When the short swinging arm 1408 swings downward such that the first gear 1418 rotates backward, the second gear 1424 will rotate forward, causing the second rotating shaft 1420 to rotate forward. Therefore, no matter whether the short swinging arm 1408 swings upward or downward, the second rotating shaft 1420 will continue rotating forward. When the second rotating shaft 1420 rotates forward, the third sprocket 1426 will be driven to rotate forward. The fourth sprocket 1430 and the fifth sprocket 1432 are arranged on the third rotating shaft 1428. The fourth sprocket 1430 is connected to the third sprocket 1426. When the third sprocket 1426 rotates forward, the fourth sprocket 1430 is driven to rotate forward, thereby further driving the third rotating shaft 1428 and the fifth sprocket 1432 to rotate forward. The sixth sprocket 1436 is arranged on the fourth rotating shaft 1434. The sixth sprocket 1436 is connected to the fifth sprocket 1432. When the fifth sprocket 1432 rotates forward, the sixth sprocket 1436 is driven to rotate forward, thereby further driving the fourth rotating shaft 1434 to rotate forward. The power generator 1438 converts the rotational energy of the fourth rotating shaft 1434 into electric energy and stores the electric energy for use by the electric vehicle.

In one embodiment, the third rotating shaft 1428, the fourth sprocket 1430, and the fifth sprocket 1432 of the second transmission mechanism can be omitted and the third sprocket 1426 can be directly connected to the sixth sprocket 1436.

Based on the foregoing description, it can be known that the present invention excludes the damping in the vibration absorber 12 to obtain greater vibration amplitude. Then, the front amplifying arm 1402 and the rear amplifying arm 1404 are used to amplify the vibration amplitude of the vibration absorber 12 to generate greater vibration energy. The first transmission mechanism can convert the vibration energy of up-and-down vibration into rotational energy in the same rotation direction. The second transmission mechanism then transmits the rotational energy to the power generator 1438 to generate electric energy. Since the vibration energy of the up-and-down vibration is converted into horizontal rotational energy, the driver and passengers of the electric vehicle will still not feel severe vibration because the vibration absorber 12 does not include damping.

FIG. 1 and FIG. 2 only teach that the vibration of a single wheel 20 is used to generate electric energy, but the present invention is not limited thereto. The present invention can also convert the vibration energy of multiple wheels 20 into electric energy at the same time.

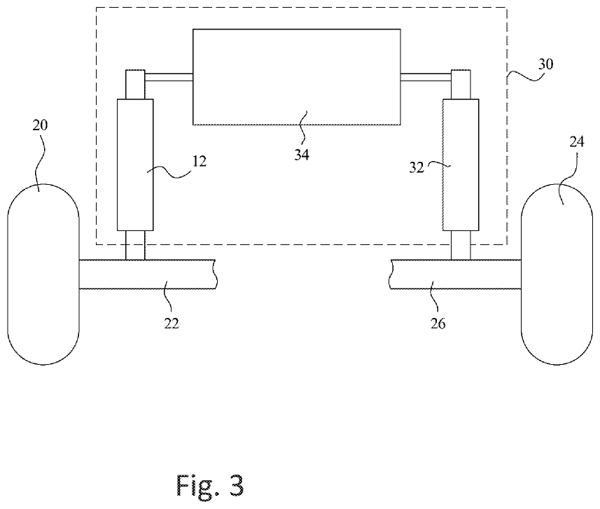

FIG. 3 shows another embodiment of the device for supplying power to the electric vehicle of the present invention. In addition to the vibration absorber 12 shown in FIG. 1, the device 30 for supplying power to the electric vehicle in FIG. 3 also includes a vibration absorber 32 and an energy converter 34, where the vibration absorber 32 excludes damping. The vibration absorber 32 may be, but not limited to, a part of the suspension system of the electric vehicle. In one embodiment, the vibration absorber 32 may be a MacPherson vibration absorber. The vibration absorber 32 is connected to the axle 26 of the wheel 24 of the electric vehicle, but the invention is not limited thereto. In one embodiment, the axle 22 of the wheel 20 and the axle 26 of the wheel 24 may be identical. The vibration absorbers 12 and 32 are connected to the energy converter 34. When the electric vehicle drives such that the wheels 20 and 24 vibrate, the vibration absorbers 12 and 32 will vibrate up and down with the upward and downward vibrations of the wheels 20 and 24, thereby generating vibration energy. The energy converter 34 converts the vibration energy generated by the vibration absorbers 12 and 32 into electric energy and stores the electric energy for use by the electric vehicle. In the present invention, since the vibration absorbers 12 and 32 exclude damping, they can generate greater vibration energy such that greater electric energy is obtained. The energy converter 34 can convert the up-and-down vibration of the wheels 20 and 24 into a horizontal rotation using a combination of sprockets and/or gears. Therefore, even if the vibration absorbers 12 and 32 have no damping, the driver and passengers of the electric vehicle will still not feel severe vibration. The device 30 for supplying power to the electric vehicle of the present invention can achieve the vibration absorbing function.

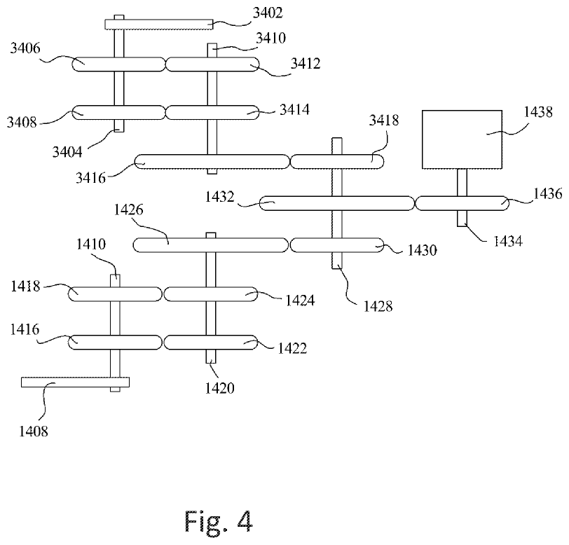

FIG. 4 shows a top view of the energy converter 34 of FIG. 3. Each of the energy converter 34 of FIG. 4 and the energy converter 14 of FIG. 2 also includes a front amplifying arm 1402 (not shown in FIG. 4), a rear amplifying arm 1404 (not shown in FIG. 4), and a connecting rod 1406 (not shown in FIG. 4), a short swinging arm 1408, a first rotating shaft 1410, a first non-return bearing 1412 (not shown in FIG. 4), a second non-return bearing 1424 (not shown in FIG. 4), a first sprocket 1416, a first gear 1418, a second rotating shaft 1420, a second sprocket 1422, a second gear 1424, a third sprocket 1426, a third rotating shaft 1428, a fourth sprocket 1430, a fifth sprocket 1432, a fourth rotating shaft 1434, a sixth sprocket 1436 and a power generator 1438. In addition, the energy converter 34 of FIG. 4 further includes a second front amplifying arm (not shown in FIG. 4), a second rear amplifying arm (not shown in FIG. 4), and a second connecting rod (not shown in FIG. 4), a second short swinging arm 3402, a fifth rotating shaft 3404, a third non-return bearing (not shown in FIG. 4), a fourth non-return bearing (not shown in FIG. 4), a seventh sprocket 3406, a third gear 3408, a sixth rotating shaft 3410, an eighth sprocket 3412, a fourth gear 3414, a ninth sprocket 3416 and a tenth sprocket 3418.

In the energy converter 34, the second front amplifying arm is connected to the vibration absorber 32. When the vibration absorber 32 vibrates up and down, the second front amplifying arm will rotate back and forth repeatedly. The second rear amplifying arm is connected to the second front amplifying arm. When the second front amplifying arm rotates back and forth, the second rear amplifying arm will swing up and down. The second connecting rod is connected to the second rear amplifying arm. When the second rear amplifying arm swings up and down, the second connecting rod will move up and down. The second short swinging arm 3402 is connected to the second connecting rod. When the second connecting rod moves up and down, the second short swinging arm 3402 swings up and down. The functions of the second front amplifying arm and the second rear amplifying arm are to amplify the vibration of the vibration absorber 32 to generate greater vibration energy.

In FIG. 4, the fifth rotating shaft 3404, the third non-return bearing (not shown in FIG. 4), the fourth non-return bearing (not shown in FIG. 4), the seventh sprocket 3406, and the third gear 3408 form a third transmission mechanism. The fifth rotating shaft 3404 is connected to the second short swinging arm 3402. When the second short swinging arm 3402 swings up and down, the fifth rotating shaft 3404 will rotate back and forth repeatedly. The third non-return bearing and the fourth non-return bearing of the third transmission mechanism are arranged on the fifth rotating shaft 3404. The seventh sprocket 3406 and the third gear 3408 are respectively arranged on the third non-return bearing and the fourth non-return bearing. When the fifth rotating shaft 3404 rotates forward (i.e., rotates clockwise or rotates in the first direction), the seventh sprocket 3406 will rotate forward and the fourth non-return bearing will prevent the third gear 3408 from rotating forward with the fifth rotating shaft 3404. When the fifth rotating shaft 3404 rotates backward (i.e., rotates counterclockwise or rotates in the second direction), the third gear 3408 will rotate backward and the third non-return bearing will prevent the seventh sprocket 3406 from rotating backward with the fifth rotating shaft 3404. The actions of the third transmission mechanism of the present invention are not limited to the foregoing description. For example, the third non-return bearing is used to prevent the seventh sprocket 3406 from rotating forward and the fourth non-return bearing is used to prevent the third gear 3408 from rotating backward. As a result, the seventh sprocket 3406 can only rotate backward and the third gear 3408 can only rotate forward. The function of the third transmission mechanism is to convert the vibration energy of upward vibration and the vibration energy of downward vibration into rotational energy in the same rotation direction.

Each of the second transmission mechanisms of FIG. 4 and FIG. 2 also has a second rotating shaft 1420, a second sprocket 1422, a second gear 1424, a third sprocket 1426, a third rotating shaft 1428, and a fourth sprocket 1430, a fifth sprocket 1432, the fourth rotating shaft 1434, and a sixth sprocket 1436. In addition, the second transmission mechanism in FIG. 4 further includes a sixth rotating shaft 3410, an eighth sprocket 3412, a fourth gear 3414, a ninth sprocket 3416, and a tenth sprocket 3418. The eighth sprocket 3412, the fourth gear 3414, and the ninth sprocket 3416 are arranged on the sixth rotating shaft 3410. The eighth sprocket 3412 is connected to the seventh sprocket 3406. When the second short swinging arm 3402 swings upward such that the seventh sprocket 3406 rotates forward, the eighth sprocket 3412 will rotate forward to drive the sixth rotating shaft 3410 to rotate forward. The fourth gear 3414 is connected to the third gear 3408. When the second short swinging arm 3402 swings downward such that the third gear 3408 rotates backward, the fourth gear 3414 will rotate forward such that the sixth rotating shaft 3410 rotates forward. Therefore, no matter whether the second short swinging arm 3402 swings upward or downward, the sixth rotating shaft 3410 will continue rotating forward. When the sixth rotating shaft 3410 rotates forward, the ninth sprocket 3416 will be driven to rotate forward. The tenth sprocket 3418 is arranged on the third rotating shaft 1428. The tenth sprocket 3418 is connected to the ninth sprocket 3416. When the ninth sprocket 3416 rotates forward, the tenth sprocket 3418 is driven to rotate forward, thereby further driving the third rotating shaft 1428 and the fifth sprocket 1432 to rotate forward. When the fifth sprocket 1432 rotates forward, the sixth sprocket 1436 is driven to rotate forward, thereby further driving the fourth rotating shaft 1434 to rotate forward. The power generator 1438 converts the rotational energy of the fourth rotating shaft 1434 into electric energy and stores the electric energy for use by the electric vehicle.

In the embodiment of FIG. 3, the device 30 for supplying power to the electric vehicle converts the vibration energy of two wheels into electric energy. However, in other embodiments, the device 30 for supplying power to the electric vehicle can also convert the vibration energy of two or more wheels into electric energy.

In one embodiment, when the size of the electric vehicle is large such that the distance between the wheels is too far, each wheel can be equipped with one device 10 for supplying power to the electric vehicle of FIG. 1.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A device for supplying power to an electric vehicle, the device comprising:
a vibration absorber excluding damping, wherein the vibration absorber vibrates up and down to generate vibration energy as wheels of the electric vehicle vibrate up and down; and
an energy converter connected to the vibration absorber and configured to convert the vibration energy into electric energy and store the electric energy for use by the electric vehicle.

2. The device for supplying power to the electric vehicle according to claim 1, wherein the energy converter comprises:
a front amplifying arm connected to the vibration absorber, wherein the front amplifying arm rotates as the vibration absorber vibrates up and down;
a rear amplifying arm connected to the front amplifying arm, wherein the rear amplifying arm swings up and down as the front amplifying arm rotates;
a connecting rod connected to the rear amplifying arm, wherein the connecting rod moves up and down as the rear amplifying arm swings up and down;
a short swinging arm connected to the connecting rod, wherein the short swinging arm swings up and down as the connecting rod moves up and down;
a first transmission mechanism connected to the short swinging arm, wherein the first transmission mechanism rotates as the short swinging arm swings up and down;
a second transmission mechanism connected to the first transmission mechanism, wherein the second transmission mechanism rotates as the first transmission mechanism rotates; and
a power generator connected to the second transmission mechanism, wherein the power generator generates the electric energy as the second transmission mechanism rotates.

3. The device for supplying power to the electric vehicle according to claim 2, wherein the first transmission mechanism comprises:
a first rotating shaft connected to the short swinging arm, wherein the first rotating shaft rotate forward and backward as the short swinging arm rotates forward and backward;
a first non-return bearing arranged on the first rotating shaft;
a second non-return bearing arranged on the first rotating shaft;
a first sprocket arranged on the first non-return bearing, wherein when the first rotating shaft rotates back and forth, the first non-return bearing prevents the first sprocket from rotating in a first direction; and
a first gear arranged on the second non-return bearing, wherein when the first rotating shaft rotates back and forth, the second non-return bearing prevents the first gear from rotating in a second direction opposite to the first direction.

4. The device for supplying power to the electric vehicle according to claim 3, wherein the second transmission mechanism comprises:
a second rotating shaft;
a second sprocket arranged on the second rotating shaft and connected to the first sprocket;
a second gear arranged on the second rotating shaft and connected to the first gear;
a third sprocket arranged on the second rotating shaft;
a third rotating shaft;
a fourth sprocket arranged on the third rotating shaft and connected to the third sprocket;
a fifth sprocket arranged on the third rotating shaft;
a fourth rotating shaft connected to the power generator; and
a sixth sprocket arranged on the fourth rotating shaft and connected to the fourth sprocket.
